(19) United States
(12) Patent Application Publication
(10) Pub. No.: US 2016/0201384 A1
(43) Pub. Date: Jul. 14, 2016

(54) PATIO DOOR WITH PET DOORWAY

(71) Applicant: Joan Heidenreiter, Avondale, AZ (US)

(72) Inventor: Joan Heidenreiter, Avondale, AZ (US)

(21) Appl. No.: 14/595,405

(22) Filed: Jan. 13, 2015

(51) Int. Cl. E06B 7/32; E05B 1/00; E05D 15/06; E05C 19/00; E06B 3/50; E05D 15/48

(52) U.S. Cl. CPC E06B 7/32; E06B 3/5081; E05D 15/48; E05D 15/0604; E05D 15/0652; E05D 15/0656; E05D 15/0686; E05C 19/00; E05B 1/0053; E05D 2015/485

(57) ABSTRACT

A sliding door with a pet doorway comprising: a top portion; a bottom portion; a pet doorway positioned in the bottom portion; a panel capable of covering the pet doorway; and at least two locks over the pet doorway, where the at least two locks attach to locking flaps on the panel. Preferably, the top portion of the sliding door includes: a top panel; two side panels extending downward from the top panel; a metal panel extending between the two side panels, where the top panel connects to top ends of the side panels and the metal panel connects to bottom ends of the side panels; and a screen surrounded by the top panel, two side panels and metal panel. A security panel may be provided for the pet doorway.

### BACKGROUND OF THE INVENTION

1. Field of Invention

The present invention was generally a patio door that includes a pet doorway to allow entry and exit of a pet when in a closed position.

2. Description of Related Art

In most residential properties, a sliding door is commonly used for entrance onto an adjoining patio or deck, where the sliding door may include both glass and screen panels to allow visibility through the door. The sliding door is also used to allow a pet, especially a dog, to leave the residence in order to enjoy the outdoor area adjoining to the residence. Many times the pet is released so that it may handle body functions in the outdoors and then return inside after the pet is finished with their bodily duties. Normally, an owner must open or closes the door to allow the pet to enter and leave. Presently there are some doorways available for pets to transverse through a hinged door that allow the pet to enter and exit through an opening within the door. Sliding doors however have limited applications with a pet doorway design within the sliding door to allow for the entry and exit of pets in unassisted manner. As a consequence, it would be advantageous to have a sliding door that includes the opening for a pet to transfer through as needed.

### SUMMARY OF THE INVENTION

The present invention relates to a sliding door with a pet doorway comprising: a top portion; a bottom portion; a pet doorway positioned in the bottom portion; a panel capable of covering the pet doorway; and at least two locks over the pet doorway, where the at least two locks attach to locking flaps on the panel. Preferably, the top portion of the sliding door includes: a top panel; two side panels extending downward from the top panel; a metal panel extending between the two side panels, where the top panel connects to top ends of the side panels and the metal panel connects to bottom ends of the side panels; and a screen surrounded by the top panel, two side panels and metal panel. A security panel may be provided for the pet doorway.

### BRIEF DESCRIPTION OF DRAWINGS

FIG. 1 depicts a patio sliding door in accordance with the present invention.

FIG. 2 depicts a security panel that is placed over a pet doorway within the sliding patio door.

FIG. 3 depicts glass panels that are used in conjunction with the pet doorway in accordance with the present invention.

### DETAILED DESCRIPTION

The present invention relates to a sliding door that includes a pet doorway for the entry and exit of a pet. The sliding door according to the present invention includes metal panels that support the screen, which provides the body portion of the top of the sliding door. The lower portion of the sliding door according to the present invention also includes metal panels with an opening provided for a pet doorway. Surrounding the panels are rubber flexible panels on each side to provide a tight seal of the sliding door. Rollers are provided at the top edge and bottom edge of the sliding door along with a door track at the bottom of the sliding door. Panels are also provided to cover the pet doorway as needed for security purposes.

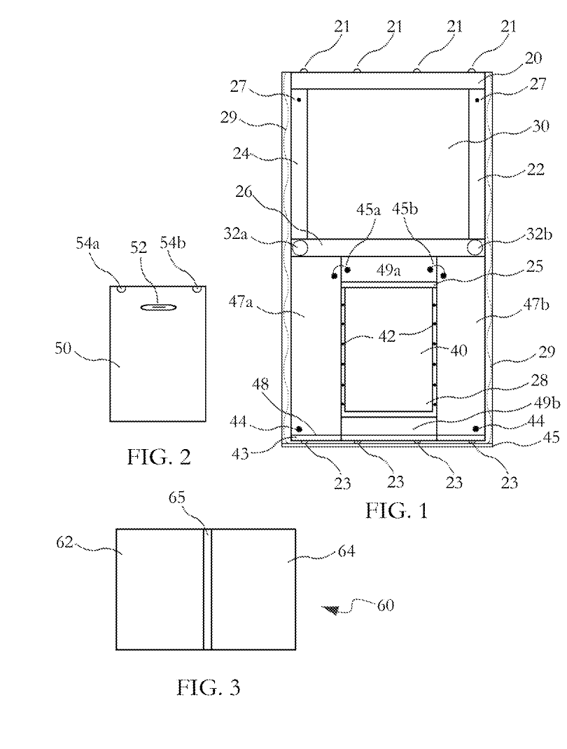

With respect to FIG. 1, a sliding door in accordance with the present invention is depicted. The sliding door in FIG. 1 includes a top panel 20 with aluminum side panels 22, 24 extending from each side of the top panel 20. The side panels 22, 24 adjoin to a metal panel 26 to surround a screen 30 as shown in FIG. 1. The side panels 22, 24 further include a release screw 27 at each respective top portion of the respective side panels. Along the top edge of the top panel 20 are rollers 21 that allow for the movement of the sliding door within a track provided in a doorway opening. The top panel 20 and side panels 22,24 include mechanisms the enable movement of the panels. The mechanisms allow the each respective panel to pop into place and rotate about hinges to allow the user access under the panels.

Further at a bottom end of the sliding door are rollers 23 at the bottom edge. A sliding door track 45 is also provided at the bottom edge of the door according to the present invention. Release screws 44 are provided at the bottom edge to release a bottom panel 48.

The middle panel 26 may also include locks 32a, 32b at each end of the panel. These locks 32a, 32b help to secure the sliding door into a locked position. Below the metal panel 26 is a lower panel 49a. Panel 49a runs along the top of a pet doorway 40. At the bottom of the pet doorway is a bottom panel 49b. Along the side of the pet doorway 40 are lower side panels 47a, 47b, on each respective side of the pet doorway. In one particular embodiment, the lower side panels 47a, 47b may be made of metal. The pet doorway 40 may include a flexible material creating a door that is easily transferable by the pet. This flexible door may be a flap-style door that goes back to a closed position after the pet has transferred through the pet doorway 40. Along both sides of the pet doorway 40 are screws 42 that hold the side panel 47a into place.

A locking mechanism is provided for the pet doorway in the form of drop-down locks 45a, 45b. The drop-down locks 45a, 45b join to locking flaps 54a, 54b shown in FIG. 2. FIG. 2 includes a security panel 50 that is placed over the pet doorway 40 in order to securely lock the opening and avoid entry by any thief or criminal. The locking flaps 54a, 54b adjoin to the drop-down locks 45a, 45b to secure the security panel into place. The security panel 50 may also includes a handle 52 to allow the user to move the panel 50 into place in the pet doorway 40.

In reference FIG. 3, a glass panel 60 is depicted to provide to cover the pet doorway 40. The glass panel 60 may include a sliding glass door 52 on one side of a metal panel 65. On the opposing side of the metal panel 65 a stationary glass panel 64 is provided. This panel may be incorporated into the pet doorway 40 to essentially seal the opening with a glass panel. It provides an alternative when the pet doorway 40 is not in use by a pet.

The present invention essentially provides a sliding door that includes a pet doorway. The pet doorway included in the present invention has interchanging panels to lock and secure the pet doorway and further may be covered with glass should the pet doorway inoperable or not in use for a period of time. The instant invention has been shown and described in what it considers to be the most practical and preferred embodiments. It is recognized, however, that departures may be made there from within the scope of the invention and that obvious modifications will occur to a person skilled in the art.

What is claimed is:

1. A sliding door with a pet doorway comprising:
a. a top portion;
b. a bottom portion;
c. a pet doorway positioned in the bottom portion;
d. a panel capable of covering the pet doorway; and
e. at least two locks over the pet doorway, where the at least two locks attach to locking flaps on the panel.

2. The sliding door according to claim 1, where the top portion includes:
a. a top panel;
b. two side panels extending downward from the top panel;
c. a metal panel extending between the two side panels, where the top panel connects to top ends of the side panels and the metal panel connects to bottom ends of the side panels; and
d. a screen surrounded by the top panel, two side panels and metal panel.

3. The sliding door according to claim 2, where the two side panels include a hinge at the top end of each side panel.

4. The sliding door according to claim 2, where a plurality of rollers run along a top edge of the top panel.

5. The sliding door according to claim 2, where the metal panel includes a lock at each respective end of the metal panel.

6. The sliding door according to claim 1, where the pet doorway is covered by a flexible material.

7. The sliding door according to claim 1, where the panel include a handle.

8. The sliding door according to claim 1, further including a glass panel to cover the pet doorway.

9. The sliding door according to claim 8, where the glass panel is a stationary glass panel.

10. The sliding door according to claim 8, where the glass panel is a sliding glass panel.

11. The sliding door according to claim 1, where a plurality of rollers are along a bottom edge of the bottom portion.

12. The sliding door according to claim 1, where the bottom edge of the bottom portion includes a door track.
